(19) United States
(12) Patent Application Publication
(10) Pub. No.: US 2023/0018881 A1
(43) Pub. Date: Jan. 19, 2023

(54) TWO-WIRE POWER LINE COMMUNICATION

(71) Applicant: Focus Universal Inc., Ontario, CA (US)

(72) Inventor: Desheng Wang, Diamond Bar, CA (US)

(21) Appl. No.: 17/750,226

(22) Filed: May 20, 2022

Related U.S. Application Data
(60) Provisional application No. 63/190,928, filed on May 20, 2021.

(51) Int. Cl. A01G 25/16; H04B 3/54

(52) U.S. Cl. CPC A01G 25/167; H04B 3/542

(57) ABSTRACT

Disclosed here are systems and methods for controlling an irrigation system using a two-wire electrical path. The system includes a controller, decoders, and sensors all connected by a two-wire wired connection. The controller controls the decoders and provides parameters to the sensors in an open-loop operation mode. The sensors may control one or more of the decoders in a closed-loop operation mode. The system may further operate in a hybrid operation mode providing both open- and closed-loop operation. The various components of the system communicate using a power line communication protocol which places data on a frequency or bandwidth separate from the power signal.

### CROSS-REFERENCE TO RELATED APPLICATIONS

This application claims priority to U.S. Prov. App. No. 63/190,928 filed May 20, 2021 and entitled “TWO WIRE IRRIGATION SYSTEM WITH POWER LINE COMMUNICATION,” which is expressly incorporated by reference herein in its entirety for all purposes.

### BACKGROUND

### Field

The present disclosure generally relates to automation and control of irrigation systems.

### Description of Related Art

Large irrigation systems use sprinklers, sensors or other components that can be powered and controlled using various systems and methods. Normally, 24 Volt AC power lines are used that can be several miles long and that serve many hundreds of components. Various techniques have been devised to power and control such irrigation systems.

### SUMMARY

In some aspects, the techniques described herein relate to a system for irrigating a geographic area, including: a controller including a first processor electrically connected to a first PLC transceiver, the transceiver including at least one crystal oscillator, and a first memory electrically connected to the first processer, the memory including instructions for a PLC protocol using a data rate in excess of 10000 bits per second; a universal device electrically connected to the controller, the universal device including an IEEE 802.11 protocol transceiver and a second PLC transceiver, a second processor, and a second memory storing a first copy of the PLC protocol; at least one decoder electrically connected to the controller, the decoder including a third PLC transceiver, a third processor, and a third memory storing a second copy of the PLC protocol; at least one sensor electrically connected to the controller and one or more of the at least one decoder, the at least one sensor including a fourth PLC transceiver, a fourth processor, and a fourth memory storing a third copy of the PLC protocol; wherein, when the system is powered, the universal device requests identification information from the at least one decoder and the at least one sensor using the first copy of the PLC protocol stored on the second memory and executing on the second processor, the at least one decoder receives the request and sends the identification information using the second copy of the PLC protocol stored in the third memory and executing on the third processor, the at least one sensor receives the request and sends the identification information using the third copy of the PLC protocol stored in the fourth memory and executing on the fourth processor, and the controller uses the identification information to create software for a user to control the at least one decoder and the at least one sensor using the controller.

In some aspects, the techniques described herein relate to a system, wherein the controller sends commands to either one or more of the at least one decoder, one or more the at least one sensor, or both, and the one or more the at least one decoder, the one or more of the at least one sensor, or both send an acknowledgement of the command to the controller.

In some aspects, the techniques described herein relate to a system, wherein the at least one sensor sends a command to one or more of the at least one decoder.

In some aspects, the techniques described herein relate to a system, wherein the PLC protocol includes instructions to only encode information on a frequency above 10000 Hz.

In some aspects, the techniques described herein relate to a system, wherein each of the at least one decoder controls one or more valves.

In some aspects, the techniques described herein relate to a system, wherein the at least one sensor is a pressure sensor, a moisture sensor, or an electrical conductivity sensor.

In some aspects, the techniques described herein relate to a system, wherein the PLC protocol uses phase shift keying.

In some aspects, the techniques described herein relate to a method for operating an irrigation control system, including: connecting one or more decoders to a controller via a wired connection; programming an irrigation schedule on the controller; adding parameters to one or more sensors in electrical communication with the controller; sending commands, using a power line communication protocol, from the controller to the one or more decoders to operate one or more valves; and sending commands based on the parameters, using a power line communication protocol, from the one or more sensors the one or more decoders to operate the one or more valves.

In some aspects, the techniques described herein relate to a method, wherein when the one or more decoders are connected to the controller, control surfaces for controlling the one or more decoders are autonomously created on the controller.

In some aspects, the techniques described herein relate to a method, further including sending data from the sensors to the controller, the data being stored in a memory on the controller.

In some aspects, the techniques described herein relate to a method, wherein the power line communication is controlled by a protocol which operates in excess of 10000 bits per second.

In some aspects, the techniques described herein relate to a method, wherein the one or more sensors include a pressure sensor, a rain sensor, and a soil moisture sensor.

In some aspects, the techniques described herein relate to a system for controlling an irrigation system, including: a controller including a first processor electrically connected to a first PLC transceiver, the transceiver including at least one crystal oscillator, and a first memory electrically connected to the first processer, the memory including instructions for a PLC protocol using a data rate in excess of 10000 bits per second; at least one decoder electrically connected to the controller, the decoder including a second PLC transceiver, a second processor, and a second memory storing a copy of the PLC protocol; at least one sensor electrically connected to the controller and one or more of the at least one decoder, the at least one sensor including a third PLC transceiver, a third processor, and a third memory storing a second copy of the PLC protocol; wherein, when the system is operating, the at least one sensor sends commands to one or more of the at least one decoder and the at least one sensor sends data to the controller, and the controller stores the data in the at least one memory.

In some aspects, the techniques described herein relate to a system, further including a universal device electrically connected to the controller, the universal device including an IEEE 802.11 protocol transceiver and a fourth PLC transceiver, a fourth processor, and a fourth memory storing a third copy of the PLC protocol.

In some aspects, the techniques described herein relate to a system, wherein when the system is powered, the universal device requests identification information from the at least one decoder and the at least one sensor using the first copy of the PLC protocol stored on the second memory and executing on the second processor, the at least one decoder receives the request and sends the identification information using the second copy of the PLC protocol stored in the third memory and executing on the third processor, the at least one sensor receives the request and sends the identification information using the third copy of the PLC protocol stored in the fourth memory and executing on the fourth processor, and the controller uses the identification information to create software for a user to control the at least one decoder and the at least one sensor using the controller.

In some aspects, the techniques described herein relate to a system, wherein. the at least one sensor is a pressure sensor, a moisture sensor, or an electrical conductivity sensor.

In some aspects, the techniques described herein relate to a system, wherein each of the at least one decoder and the at least one sensor send acknowledgements to commands using the power line communication protocol.

In some aspects, the techniques described herein relate to a system, wherein one of the at least one sensor is connected directly to a decoder.

In some aspects, the techniques described herein relate to a system, further including two wires which connect the controller to the at least one decoder.

In some aspects, the techniques described herein relate to a system, wherein one or more of the at least one sensor is directly connected to the two wires at a location between the controller and the at least one decoder.

For purposes of summarizing the disclosure, certain aspects, advantages and novel features have been described herein. It is to be understood that not necessarily all such advantages may be achieved in accordance with any particular embodiment. Thus, the disclosed embodiments may be carried out in a manner that achieves or optimizes one advantage or group of advantages as taught herein without necessarily achieving other advantages as may be taught or suggested herein.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a schematic diagram of the system;

FIG. 2 shows a flowchart of a method of operating the system;

FIG. 3 shows a plan view of a user interface;

FIG. 4 shows a schematic diagram of an example transceiver;

FIG. 5 shows a circuit diagram of the coupling circuit;

FIG. 6A shows a circuit diagram of one embodiment of the crystal oscillator and integrated circuit portions of the transceiver;

FIG. 6B shows a circuit diagram of one embodiment of the switch;

FIG. 6C shows a circuit diagram of one embodiment of a sub-circuit which strips harmonics from the signal output by the switch;

FIG. 7A shows a circuit diagram of the high frequency amplifier portion of the receiver of the transceiver;

FIG. 7B shows a circuit diagram of the amplifier and mixer portion of the receiver of the transceiver;

FIG. 7C shows a circuit diagram of the ultra-narrowband filter of the receiver;

FIG. 7D shows a circuit diagram of the amplitude limiting sub-circuit of the receiver;

FIG. 7E shows a circuit diagram of the baseband decoding sub-circuit of the receiver;

FIG. 8 shows a diagram of the two crystal oscillator waves at the switch; and

FIG. 9 shows one embodiment of a control signal at the receiver.

### DETAILED DESCRIPTION OF SOME EMBODIMENTS

The headings provided herein, if any, are for convenience only and do not necessarily affect the scope or meaning of the claimed subject matter.

### Overview

Large commercial irrigation systems, such as those used on golf courses or croplands, and even some residential irrigation systems, use sprinklers, sensors or other components that are normally powered from 24 Volt AC power lines that can be several miles long and can serve many hundreds of components. Various systems have been proposed for powering and controlling the components of such a system with just two wires. For example, U.S. Pat. No. 3,521,130 to Davis et al., U.S. Pat. No. 3,723,827 to Griswold et al., and U.S. Pat. No. 4,241,375 to Ruggles disclose systems in which sprinkler valves along a cable are turned on in sequence by momentarily interrupting the power or transmitting an advance signal from time to time.

A problem with this approach is that it does not allow the operator to freely turn on or off any selected sprinkler or set of sprinklers at different times. This problem is typically resolved by providing separate controllers in the field to operate groups of sprinklers in accordance with a program or schedule stored in them or transmitted to them by radio or other means. Alternatively, it has been proposed, as for example in U.S. Pat. No. 3,578,245 to Brock, to operate individual sprinkler sets from a central location by superimposing a frequency-modulated signal or DC pulses onto the 24 V AC power line.

All of these approaches are expensive. For example, a system with hundreds of sprinklers requires miles of expensive, heavy wiring to accommodate the current drawn by a large number of valves that may be watering simultaneously. Also, heavy use of DC current may cause electrolysis issues with electrical components.

One alternative to these traditional irrigation systems are two-wire power and communications systems, such as the system disclosed in U.S. Pat. No. 7,358,626. In such systems, two wires supply both AC power and digital control communications from a controller to a plurality of decoders.

While these AC power and digital communication systems generally work well, they also have several disadvantages. First, decoder circuitry that listens for communications are sensitive to power surges by lightning. Hence, expensive, external surge devices with ground rods must be installed at short intervals along the power and communication wires.

Second, some two-wire power and communication systems use bursts of current by valve or sensor decoders to acknowledge or otherwise communicate with a central controller. These decoders rely on fixed resistor circuits to switch to a circuit path with a resistor between the common current and ground on the decoder. Since these resistor circuits resist at a fixed value, any reduction in the voltage causes a proportional reduction in the current pulse due to Ohm's Law. Therefore, if the current burst of the acknowledgement pulse is reduced sufficiently, the gateway may not recognize it and therefore will falsely determine that the decoder did not receive a command. As decoders are installed further away from a gateway or central controller, the resistance of the power and communication wires becomes significant and reduces the voltage available across the decoder. Additionally, large numbers of decoders may also further reduce voltage and increase resistance on the power and communication wires. Hence, these systems effectively become limited in size and in the number of decoders.

Moreover, decoders are component specific. That is, decoders may control valves or sensors, but not both. Sensors must be connected to a sensor decoder, which can limit the placement of the sensor, compromising the quality of the data taken by that sensor. Obviously, because a choice of decoder must be made, flexibility is greatly reduced.

For the foregoing reasons, there is a need for a system that can provide true bi-directional communication and greatly improved data rates that overcome the shortcomings of prior irrigation control systems. Accordingly, described herein are irrigation systems that use power line communication protocols over a two-wire electrical path to control components of an irrigation system, such as valves and sensors. The disclosed irrigation systems use ultra-narrowband communication protocols to enable high data rates on the two-wire electrical path to enable real time control and operation of the irrigation system. Moreover, the disclosed irrigation systems allow for open-loop operation (e.g., using a centralized controller), closed-loop operation (e.g., controlling operation using data from distributed devices such as sensors), and hybrid operation (e.g., controlling operation using both a centralized controller and data from distributed devices such as sensors). The disclosed irrigation systems are agnostic to operating systems of computing devices that connect to the controller of the irrigation system. The disclosed systems are also configured to dynamically add and remove elements from the irrigation system using a dynamic or request-based addressing system for components coupled to the irrigation system.

### Example Irrigation Systems

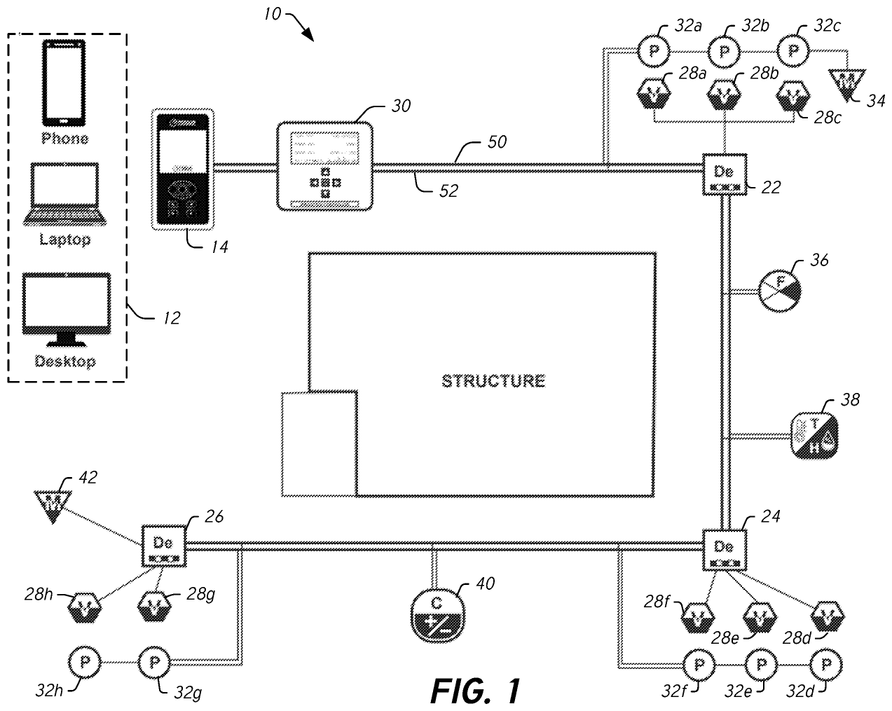

FIG. 1 illustrates an overview of an irrigation system 10 that uses ultra-narrowband two-wire power line communication according to aspects of the present disclosure. A controller 14, for example, a stand-alone purpose-designed irrigation controller, is used to program irrigation schedules and to monitor sensor data from the irrigation system 10.

A universal device 30 is in communication with the controller 14 via a wired connection and transmits acknowledgments or other device information (e.g., from sensors 32a-h, 34, 36, 38, 40, 42; decoders 22, 24, 26) to the controller 14. Additionally, the universal device 30 may transmit communication data such as commands (e.g., open or close a valve) to decoders such as watering station decoders 22, 24, 26.

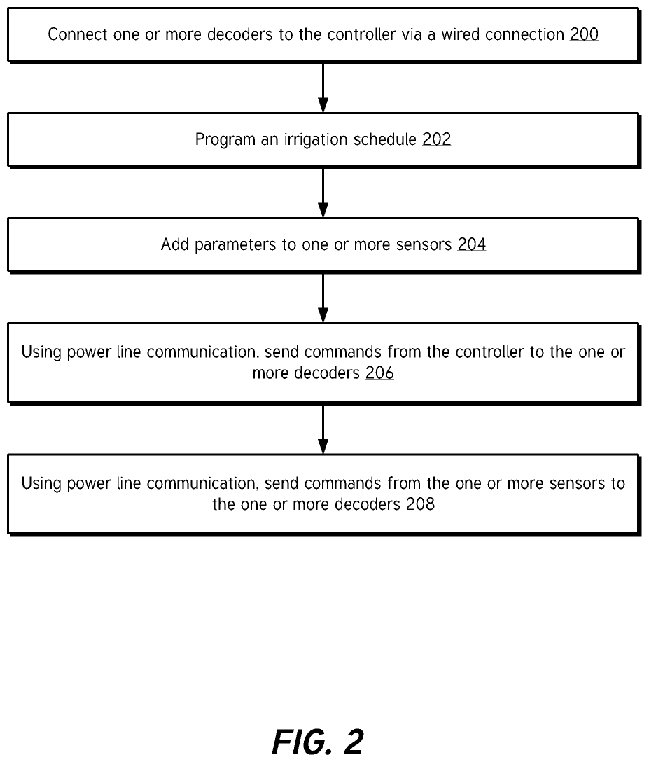

The controller 14 provides a wired connection to the decoders 22, 24, 26 and sensors 32a-h, 34, 36, 38, 40, 42, as indicated in Step 200 of FIG. 2. The controller 14 may communicate with the decoders 22, 24, 26 and sensors 32a-h, 34, 36, 38, 40, 42 without passing through the universal device 30. The controller 14 may use a power line communication (PLC) protocol to communicate with the various other components of the irrigation system 10. The communication may be bidirectional. Thus, messages may pass from the controller 14, or from a computing device 12 through the controller 14, to the decoders 22, 24, 26, or from the decoders 22, 24, 26 and the sensors 32a-h, 34, 36, 38, 40, 42 to the controller 14, or through the universal device 30 to the controller 14. Additionally, communication may originate at a sensor 32a-h, 34, 36, 38, 40, 42 and be sent to one or more decoders 22, 24, 26, as will be described in detail herein.

The controller 14 may include a further wired or wireless connection to other devices. The controller 14 may offer pass-through control to the other devices. For example, the controller 14 may include a wireless adapter configured to operate using the IEEE 802.11 protocol. The wireless adapter, and, in turn, the controller 14, may be part of a WiFi® local area network (LAN). Other devices, for example, a computing device 12, may be configured to communicate with the controller 14, and issue commands which are passed through the controller 14 to decoders 22, 24, 26 or sensors 32a-h, 34, 36, 38, 40, 42 on the irrigation system 10. Alternately, the controller 14 may have a wired connection to the universal device 30, and the universal device 30 may have a wireless adapter for the IEEE 802.11 protocol as is described in detail herein.

Two wires 50, 52 may extend from the controller 14. A first wire 50 may have a first voltage, and a second wire 52 may have a second voltage. The voltages may be fixed, that is, the voltages may stay essentially the same over time. Alternatively, the voltages on each wire may be intentionally varied with time. Still further alternatively, one wire 50 may carry current, and the other 52 may be connected to ground.

The voltage on the wires 50, 52 may be controlled in different segments of the electrical path. While two wires 50, 52 leave the controller 14, the two wires 50, 52 may be connected to a first decoder 22. From the first decoder 22, another segment of two wires 50, 52 runs to a second decoder 24. The first segment of two wires 50, 52 and the second segment of two wires 50, 52 may form a continuous electrical path. Thus, any signal sent from the controller 14 will broadcast to the end of the line, regardless of the number of segments in the electrical path. The voltage may be transformed up or down on either of the lines to achieve the desired effects in a particular line segment. Thus, wherever there is a decoder 22, 24, 26, there may also be a transformer. There may also be transformer at some point in the electrical path without a decoder being present.

The controller 14 may include a transformer, which takes the standard line power delivered by the electrical utility company and transforms it down to a lower voltage for use with the irrigation system 10. Alternatively, the transformer may be external to the controller 14 and deliver the transformed-down power to the controller 14.

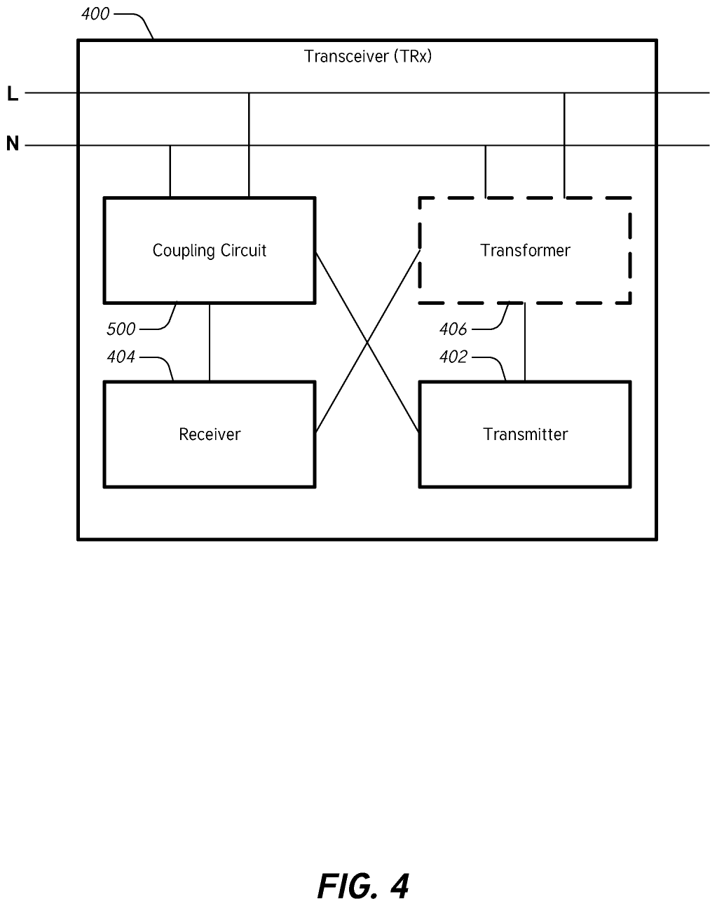

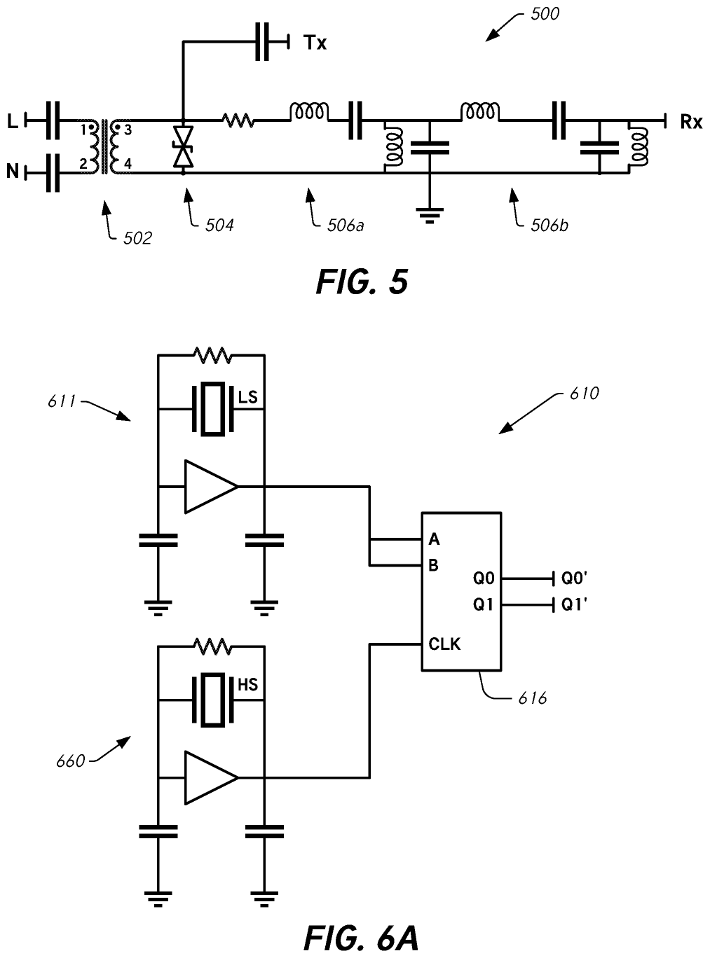

The controller 14 may include a transceiver, which is described in greater detail herein with respect to FIG. 4. The transceiver includes a coupling circuit, which is described in greater detail herein with respect to FIG. 5. In addition to providing the proper voltages for transmitting and receiving signals, the coupling circuit may also perform filtering functions. The process of transforming the voltage filters much of the low frequency signal present in the power line. The coupling circuit may include further filtering which takes place before a receiver portion of the transceiver.

Unlike typical irrigation control systems, the disclosed system 10 does not encode information on the power signal. Rather, the power signal and the data signal are separate signals on the same line. The data signal uses a power line communication (PLC) protocol. In the PLC protocol, the data may be encoded on a carrier wave. The carrier wave may have, for example, a frequency of 4 MHz or 100 kHz. In some embodiments, the frequency of the carrier may be more than about 4 MHz, less than about 100 kHz, or between about 100 kHz and about 4 MHz.

Typical systems encode data on the power line. Because the power signal has a frequency of 60 Hz in the United States, and a frequency within an order of magnitude in most places on Earth, and the protocol encodes one or two bits per cycle, the data rate caps out at 120 bits per second. With this relatively low data rate, the system is confined to simplistic commands. In fact, some typical systems resort to sending commands with a delayed start so that commands may be executed at the same time.

In contrast, the ultra-narrowband PLC protocol described herein provides a much higher data rate, in the range of kbps or Mbps. With a higher data rate, the system may execute commands nearly simultaneously without the need for working around a low data rate, as is the case with the typical systems. Further, the system may carry commands for more devices without slowing the operation of the system. Moreover, because the disclosed ultra-narrowband system has been designed to operate on commercial and residential structural power lines, the system is robust against noise. This means that in the relatively noise free environment of the irrigation two-wire system, the ultra-narrowband PLC protocol is likely to perform at near maximum data rates. The transforming of the power down to the two-wire level of between about 30 V to about 40 V has a filtering effect that reduces noise. The transforming down may be done in the transceiver, as described herein with reference to the coupling circuit, or outside of the transceiver.

The decoders 22, 24, 26 may include functionality which allows the decoder to detect what type of device is connected to the decoder. The decoder 22, 24, 26 may use a two-step process. For example, the controller 14 may send a command through the decoders 22, 24, 26 to any sensor connected to a decoder (e.g., sensor 42) and to all the valves 28a-h to respond to the command with identification information. Sensors 32a-h, 34, 36, 38, 40, 42, which are all equipped with a transceiver, are configured to respond with identification information about the sensor 32a-h, 34, 36, 38, 40, 42. The valves 28a-h, which do not include a transceiver, will not send any information. The decoder 22, 24, 26 are configured to detect over which connections data was passed and recognize that there is a sensor connected.

Alternatively, sprinkler heads connected to the valves 28a-h may come in two types. The first type may be dumb. That is, the sprinkler heads are controlled purely as a function of water pressure in the line. That is, the sprinkler head comes on when the decoder 22, 24, 26 opens a valve 28a-h which provides water to the sprinkler head and shut off when the valve 28a-h is closed by the decoder 22, 24, 26.

The second type may be a smart sprinkler head. That is, the smart sprinkler head may include processing circuitry and a transceiver similar to that of the decoder 22, 24, 26. With the additional electronics, the sprinkler head may be controlled separately from the first type of sprinkler head. Essentially, the smart sprinkler head may be viewed as a combination of a decoder, valve, and sprinkler head. Thus, these smart sprinkler heads may be connected anywhere along the electrical path in a manner similar to the decoders 22, 24, 26. Controlling a sprinkler head individually may be valuable if the type and function of irrigation performed by the sprinkler head is different from other sprinkler heads. Thus, the individually controlled sprinkler head may be located in physical proximity to other sprinkler heads, but may be operated at a different time, or for a different duration. Including individually controlled heads along with “dumb” sprinkler heads allows a user to increase or maximize customization of control while still reducing or minimizing cost of material, particularly relative to expensive electrical control components. In these cases, the smart sprinkler heads are configured to respond with information, and the decoder through which the smart sprinkler head is connected, if the smart sprinkler head is connected through a decoder, is configured to recognize the smart sprinkler head.

The irrigation system 10 includes universal decoders 22, 24, 26. Typical systems often include two types of decoders. One type of decoder may be for controlling operation of valves. The second type of decoder may be for use with sensors. The decoders 22, 24, 26 of the irrigation system 10 are agnostic to the type of device which is connected, making the decoders universal. For example, if a decoder 26 has two or more possible connections, a valve 28g, 28h may be connected to one of the connections on the decoder 26, and a sensor 42 may be connected to the other connection on the decoder 26. The decoder 26 may operate in a pass-through mode with respect to the sensor 42, that is, the decoder 26 may simply pass data and commands from the controller 14 through to the sensor 42, and pass data, commands, and acknowledgements from the sensor 42 through to the irrigation system 10 without altering the data, commands, or acknowledgements. Moreover, the decoder 26 may not communicate data or commands to the sensor 42 and may not receive any commands or data from the sensor 42. Alternatively, the decoder 26 may take commands from the sensor 42, as is discussed in greater detail herein.

The disclosed two-wire irrigation system 10 may operate as a hybrid system. That is, the irrigation system 10 may simultaneously operate as both an open loop system with portions of subsystems operating as a closed loop system. Any valve 28a-h or smart sprinkler head may be controlled both by the controller 14 in an open loop, and by one or more sensors 32a-h, 34, 36, 38, 40, 42, if any are present, in a closed loop. It should be noted, however, that the protocol is designed such that the controller 14 and sensors 32a-h, 34, 36, 38, 40, 42 do not send the same commands at the same time. Rather, control may be split between the controller 14 and the one or more sensors 32a-h, 34, 36, 38, 40, 42 depending on which of the controller 14 and one or more sensors 32a-h, 34, 36, 38, 40, 42 is best positioned to issue the command. For example, a sensor 34, 42 which senses moisture in the soil may detect that the moisture level has fallen too low, and send a command to a decoder 22, 24, 26 or to an individual smart sprinkler head. The sensor 34, 42 may also send data to the controller 14 informing the controller 14 of the command sent to the decoder 22, 24, 26. The controller 14 may send commands to all of the decoders 22, 24, 26 per an irrigation schedule as per usual. The irrigation system 10 uses the disclosed PLC protocols that allows for much higher data rates than typical systems. The improved data rates allow for many more devices to be part of the irrigation system 10 and for all of the devices to operate (e.g., send and receive commands, respond to commands, send measurement data, etc.) in near real time. The specifics of the operation of the PLC protocol and open and closed loop operation are discussed in greater detail in Applicant's Patent Cooperation Treaty Publication No. WO 2021/107961 published Jun. 3, 2021 and entitled “SYSTEM AND METHOD FOR POWER LINE COMMUNICATION,” the entire contents of which is incorporated herein by reference for all purposes.

Alternatively, the sensors 32a-h, 34, 36, 38, 40 may be connected directly to the wiring and not directly to a decoder. Because sensors 32a-h, 34, 36, 38, 40 include all the required circuitry and components to communicate with the controller 14 directly, it is not required for them to be connected to a decoder 22, 24, 26, although any individual sensor may be, as is the case with sensor 42. The sensors 32a-h, 34, 36, 38, 40 may operate as their own decoder because the sensors include a processor, a memory electrically connected to the processor, and a PLC protocol capable transceiver electrically connected to the processor.

Sensors 32a-h, 34, 36, 38, 40, 42 may provide data which is stored in a data store in the controller 14. Controller 14 may include a memory for storing data from the sensors 32a-h, 34, 36, 38, 40, 42. For example, the irrigation system 10 may include a sensor 32a-h which senses pressure in a branch line of sprinkler heads. The pressure sensor 32a-h may be located just downstream of a valve 28a-h actuated by a decoder 22, 24, 26. Through several cycles of operation, the pressure sensor 32a-h may take data, send the data to the controller 14, and the controller 14 may store the data up to a certain time limit in a data store which may be accessed by the controller 14. For example, the data store may store a week, two weeks, or a month of data. The amount may be chosen based on the amount of memory or the system's use of the data.

The data in the data store may be used in establishing baseline operating parameters. The controller 14, may use algorithms stored in another block of memory, which may be either physically separate from the memory containing the data store or may be a partition of the same memory. The algorithm, executed by a processor on the controller 14, may use the data stored in the data store to determine a historical baseline for the pressure of the line at the sensor 32a-h. Thus, the algorithm may determine a range of pressures in which the line normally operates. The controller 14 may then store this determination in memory. The process may be referred to as a “learning period.” Once the learning period is complete, the controller 14 may use the range of normal pressure to determine if there is a fault in the system at or near the location of the pressure sensor 32a-h. That is, if the pressure sensor 32a-h reports data that is compared to the normal range determined by the algorithm, and is out of the data range, the controller 14 may have instructions stored in memory and executed on the processor which cause the controller 14 to issue an alert as to a system fault. Alternatively, the sensor 32a-h may store the normal parameters itself. If the sensor 32a-h takes a measurement outside of the parameters, the sensor 32a-h may send data to the controller 14 indicating that condition, and may issue a command to a decoder 22, 24, 26 to turn off a valve 28a-h. This process is discussed in greater detail herein.

Each decoder 22, 24, 26 may be connected to a plurality of valves 28a-h. The valves 28a-h may be electrically actuated by the decoder 22, 24, 26. Each valve 28a-h may control water flow to one or more sprinkler heads for irrigation of an area. As discussed herein, each decoder 22, 24, 26 may be connected to a number of pressure sensors (e.g., pressure sensors 32a-32h) equal to the number of valves connected to the decoder. Alternatively, the decoder 22, 24, 26 may be electrically connected to only one valve and/or fewer pressure sensors than there are valves. Pressure sensors 32a-h monitor pressure in the irrigation lines including the valves 28a-h controlled by the decoder 22, 24, 26. In some embodiments, the pressure sensors 32a-h may be connected to the wiring directly rather than through the decoder 22, 24, 26. Using the connection to the wires 50, 52, the pressure sensors 32a-h may communicate directly with the controller 14 and decoders 22, 24, 26 on the irrigation system 10.

The irrigation system 10 may support a plurality of sensors 32a-h, 34, 36, 38, 40, 42. The irrigation system 10 may include pressure sensors 32a-h, flow sensors 36, current sensors, rain gauge sensors, soil moisture sensors 34, 42, temperature sensors, humidity sensors, combination temperature and humidity sensors 38, electrical conductivity sensors 40, sensors which detect the level of herbicide in the soil, and sensors which detect the level of insecticide in the soil. Each of these sensors 32a-h, 34, 36, 38, 40, 42 may be connected either to a decoder 26 or directly to the two wires 50, 52. The sensors may be connected in parallel. The sensors 32a-h, 34, 36, 38, 40, 42 may send data, commands, and acknowledgements on the two wires 50, 52, either directly or through a decoder 22, 24, 26. The sensors 32a-h, 34, 36, 38, 40, 42 may receive data and commands from the controller 14 or a universal device 30 in communication with the controller 14. Using the PLC protocol disclosed herein, the irrigation system 10 may include far more sensors, even hundreds or thousands of sensors, and still provide near real time data due to the increased data rate offered by the PLC protocol.

In some embodiments, the controller 14 includes a universal device 30 which provides device management functions. In other embodiments, the universal device 30 may be a separate device in communication with the controller 14 via PLC. Regardless of the physical arrangement, the controller 14 and the universal device 30 work in coordination to control the devices and sensors of the irrigation system 10.

The universal device 30 may perform various device management functions and may allow wireless access to devices which do not natively use the PLC protocol, to communicate on the network. The device management functions may allow the controller 14, or a computing device 12, connected to the universal device 30, either through a wired or wireless connection, to send control signals for controlling various functions of one or more of the decoders 22, 24, 26 or sensors 32a-h, 34, 36, 38, 40, 42 on the irrigation system 10, or for setting parameters used by the sensors 32a-h, 34, 36, 38, 40, 42 for closed loop functions. Thus, the universal device 30 performs functions in enabling the open-loop operation of the irrigation system 10. Alternatively, the universal device 30 may be integrated with the controller 14, so that they are a single device, both physically and in operation.

The computing device 12 may be in communication with the universal device 30. The universal device 30 may include programming which allows the universal device 30 to interoperate with computing devices 12 using various operating systems. Because of this feature, not only may more than one computing device 12 be used with the irrigation system 10, but each computing device 12 may have a different operating system. The irrigation system 10 may operate with only a single computing device 12 accessing the irrigation system 10 through the universal device 30 at a time, or the irrigation system 10 may allow more than one computing device 12 to access the universal device 30 at a time. This interoperation with any one, or a plurality of, operating systems is part of what makes the universal device 30 operate in a universal manner. The universal device 30 may receive messages from, and send messages to, any computing device 12 which a user wishes to place into operation with the irrigation system 10, making the universal device 30 agnostic with respect to the computing devices 12 as they may use any of a number of operating systems. Alternatively, the universal device 30 may only be connected to the controller 14, in which case the universal device 30 would lack the IEEE 802.11 protocol adapter.

The universal device 30 may connect to the computing device 12 through a wired or wireless connection. The wired connection may be made using an ethernet port located on the universal device 30. Additionally, the universal device 30 may connect to the two wires 50, 52 which provide the communication backbone for the irrigation system 10 as a whole, and specifically, the decoders 22, 24, 26 and sensors 32a-h, 34, 36, 38, 40, 42. The universal device 30 incorporates several modules of computer architecture. The computer architecture is an assembly of combined hardware and software, which enables the universal device 30 to perform its functions on the irrigation system 10. One of these modules of computer architecture is the foundational architecture. The foundational architecture may include a transceiver. The transceiver may be electrically connected to a processor. The processer may be electrically connected to a memory which stores the PLC protocol used on the irrigation system 10. While the two-wire wiring may provide the network infrastructure for the irrigation system 10, the PLC protocol actually forms and sends the messages used to communicate to the decoders 22, 24, 26, and sensors 32a-h, 34, 36, 38, 40, 42.

Alternatively, or in addition, the irrigation system 10 may include a controller 14 hardwired to, or integrated with, the universal device 30. The controller 14 may include touch screen technology and software which allows a user to control decoders 22, 24, 26 and set parameters for, and receive data from, sensors 32a-h, 34, 36, 38, 40, 42 on the irrigation system 10. For example, the controller 14 may include programmable logic controller technology. The programmable logic controller may be integrated with the universal device 30. Thus, the controller 14 may allow a user to use the computing device 12 as an extension of the controller 14, or to operate decoders 22, 24, 26 and sensors 32a-h, 34, 36, 38, 40, 42 on the irrigation system 10 from the controller 14. Thus, the controller 14 and the computing device 12 can be used in parallel, for example, to operate two different decoders 22, 24, 26 or send parameters to sensors 32a-h, 34, 36, 38, 40, 42, or monitor data being taken by a sensor 32a-h, 34, 36, 38, 40, 42 contemporaneously. Alternatively, the controller 14 may be a tablet computer. The tablet computer may also be integrated with the universal device 30. The controller 14 may include a wireless module which allows the controller 14 to communicate with the computing device 12 directly, and allows for pass through of computing device messages to the universal device 30.

The universal device 30 and controller 14 combination may include a screen which allows a user to view data passed from one or more decoders 22, 24, 26 or sensors 32a-h, 34, 36, 38, 40, 42 and to generate commands to be sent to one or more of the decoders 22, 24, 26 or parameters to be sent to sensors 32a-h, 34, 36, 38, 40, 42 for placing in memory or for action.

A transceiver, processor, memory, and PLC protocol are all part of the foundational architecture shared by the universal device 30, the one or more decoders 22, 24, 26, and the one or more sensors 32a-h, 34, 36, 38, 40, 42. This foundational architecture ensures that any decoder 22, 24, 26 or sensor 32a-h, 34, 36, 38, 40, 42 added to the irrigation system 10 will be able to communicate with the computing device 12 through the universal device 30, the universal device 30 itself, the decoders 22, 24, 26 on the irrigation system 10, and the sensors 32a-h, 34, 36, 38, 40, 42 on the irrigation system 10. The foundational architecture guarantees that any decoder 22, 24, 26 or sensor 32a-h, 34, 36, 38, 40, 42 designed for the irrigation system 10 will be able to interoperate with other decoders 22, 24, 26, sensors 32a-h, 34, 36, 38, 40, 42, and universal devices 30, and that control signals sent from, and data sent to, a computing device 12 accessing the irrigation system 10 through the universal device 30 will be able to operate decoders and receive feedback and data from the decoders 22, 24, 26 and sensors 32a-h, 34, 36, 38, 40, 42. Thus, with the wiring infrastructure essentially ubiquitous, and the computing architecture designed for customization, decoders 22, 24, 26 and sensors 32a-h, 34, 36, 38, 40, 42 of the disclosed irrigation system 10 may offer greatly increased functionality.

The systems and methods disclosed herein may be used to operate the irrigation system 10, or a combination irrigation/fertilization system, sometimes called a fertigation system. The fertigation system may include pipes to carry water from a tank, well, or municipal source. Pipes of various sizes may carry water, or liquid fertilizer, herbicide, pesticide, or any combination of the above, to sprinkler heads for final distribution on to grass or other plant material. Thus, the decoders 22, 24, 26 may control one valve 28a-h which allows the flow of water to the sprinkler heads, and a second valve which allows for the flow of a liquid fertilizer to the sprinkler heads. Of course, these valves may be operated simultaneously by the decoder so that both water and fertilizer are mixed and flow to the sprinkler head. This mix may be determined by past use, if any. If the addition of a liquid fertilizer system is an addition to the system as part of a larger upgrade, which includes a first-time addition of a new control system, such historical data may not be available. Such a situation is similar to a new installation in that there is no historical use data that may be used in determining scheduling. In these circumstances, sensors may be used to control the fertigation schedule. Specifically, electrical conductivity sensors 40 may be used to determine the amount of fertilizer in the soil. Electrical conductivity sensors 40 may be installed as part of the irrigation system 10 and used to control the fertilizer by controlling the delivery valves as discussed in detail herein.

In operation, the irrigation system 10 may start from a retrofit or a new installation. When starting from a retrofit, the wiring infrastructure of the previous system may be retained. This retention of the infrastructure of the previous system means greatly reduced labor and material cost for a retrofit installation. Because the wiring infrastructure is maintained, only the decoders and the controller need to be replaced. Of course, new decoders, valves, the accompanying irrigation infrastructure and sensors may be added. If the irrigation system 10 is using sprinkler heads operated by water pressure alone, the sprinkler heads do not need to be replaced. Nor do the valves 28a-h controlling flow to the sprinkler heads need to be replaced. Only if any of the pre-existing sprinkler heads or valves use some form of smart technology for actuation would they need to be replaced.

In typical systems, sensors must be directly connected to the controller or must be connected to a decoder specifically configured for use with sensors. First, this limits the locations where sensors may be practically placed. Second, this limits the usefulness of the system in gathering pertinent data to manage the irrigation system.

In a retrofit installation using the disclosed technology, sensors may be added to the irrigation system 10 at any point on the wiring. Because the sensors 32a-h, 34, 36, 38, 40 can be connected at any point on the two-wire infrastructure, the only considerations are related to the inductive and resistive effects of the wire itself on the power. The PLC signal is unaffected by distances typically found in irrigation systems, especially for carrier waves in the 100 kHz range. However, even up to 4 MHz signals may be sent more than a half mile without loss of operational effectiveness.

In a new installation using the disclosed technology, the location of decoders, the valves controlled by the decoders, and the sensors may be planned to minimize cost and maximize effectiveness. For example, soil moisture sensors may be located in low areas which may be more wet, and in likely run off areas which may retain less moisture. Accurate measurements from these sensors may prevent over or under watering. Further, data from these sensors may be retained in a data store, and algorithms stored on a memory in the controller may be executed on a processor to analyze the data to develop a watering schedule.

Once the installation of either the retrofit or new system is complete, the irrigation system 10 may be powered. The controller 14 includes instructions stored on the memory for executing self-creating software. When the irrigation system 10 is powered for the first time, or a computing device 12 is connected to the irrigation system 10 though the universal device 30, the controller 14 or the computing device 12 may send a message to the universal device 30 requesting the universal device 30 to obtain and pass identification information regarding connected decoders 22, 24, 26 and sensors 32a-h, 34, 36, 38, 40, 42. Additionally, when a new decoder 22, 24, 26 or sensor 32a-h, 34, 36, 38, 40, 42 is connected to the irrigation system 10, the decoder 22, 24, 26 or sensor 32a-h, 34, 36, 38, 40, 42 may automatically send identification information to the universal device 30. Alternatively, as part of the universal device's device management functions, the universal device 30 may detect the newly added decoder 22, 24, 26 or sensor 32a-h, 34, 36, 38, 40, 42 and the universal device 30 may request identification information from the newly added decoder 22, 24, 26 or sensor 32a-h, 34, 36, 38, 40, 42. The initialization information may include the type of decoder 22, 24, 26 or sensor 32a-h, 34, 36, 38, 40, 42, what controllable functions the decoder 22, 24, 26 or sensor 32a-h, 34, 36, 38, 40, 42 has, and what the parameters may be changed to enable the operation of a sensor 32a-h, 34, 36, 38, 40, 42 or to control the functions of an decoder 22, 24, 26.

Typical controllers use a fixed menu design. That is, the controller software uses a menu-based design that is fixed from the factory. It cannot be modified by a user, and is not created based on the devices, that is, decoders and sensors connected to the particular system. The typical controllers use this top-down design approach. This type of system is easier to execute because it can be programmed once and remains as programmed. This type of system may be contrasted with software which uses a bottom-up approach. In software that is designed using a bottom-up approach, the software designs itself and customizes itself based on the devices that are part of the system. The software may grow as devices are added over time and may also shrink if devices are removed over time.

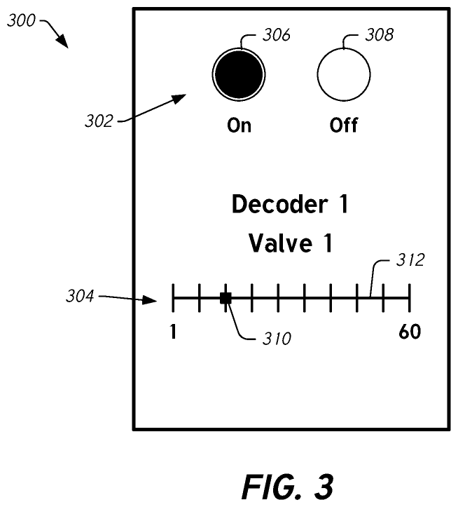

With reference to FIGS. 1 and 3, the initialization information may be used by a software application stored on the controller 14, and if one is connected, the computing device 12 to create a user interface 300. The user interface 300 may have control surfaces 302, 304 for controlling and setting the parameter values of the functions, in essence, to operate or, at least partially, program the system.

The universal device 30 may, in turn, send some or all of the identification information to the controller 14, and, if one is connected, to the computing device 12. The identification information may include an identifier for each decoder 22, 24, 26 or sensor 32a-h, 34, 36, 38, 40, 42. The identifier may be a binary sequence. The identification information may further include which features may be controlled through the user interface 300, and which type of control surface 302, 304 corresponds to each feature. The identification information may also include what control parameters correspond to the control surface 302, 304 for controlling a particular feature. Control parameters may include what category of control, that is, a time period or other category. Control parameters may also include the range of possible parameter values, as is described in detail herein.

With continued reference to FIGS. 1 and 3, the computing device includes in the algorithms stored in memory a subroutine which receives data from the universal device 30 and creates a user interface 300 on the controller 14, and, if one is connected, the computing device 12. The algorithms receive the identification information from the universal device 30. The identification information may include how many decoders 22, 24, 26 and sensors 32a-h, 34, 36, 38, 40, 42 are on the irrigation system 10, a unique identification for each, the available function or functions for the one or more decoders 22, 24, 26 and available parameters for the one or more decoders 22, 24, 26 and sensors 32a-h, 34, 36, 38, 40, 42. Using the identification information, the algorithms on the controller 14, and, if one is connected, the computing device 12 may automatically create a user interface 300. There is no action required by the user to create the user interface 300 beyond powering the irrigation system 10 or connecting the computing device 12 at a later point to the universal device 30 and opening an app including the algorithms on the computing device 12.

The user interface 300 may include one or more screens. The one or more screens may include screens which display data including a condensed amount of data from each of the sensors. Alternatively, or in addition, a single screen may include an average of the measurements taken by one type of sensor. The user interface 300 may include one or more screens for controlling the one or more functions of the one or more decoders 22, 24, 26. The one or more screens may include control surfaces 302, 304. Each decoder 22, 24, 26 or sensor 32a-h, 34, 36, 38, 40, 42 may have its own screen. These screens may be navigated using a tab system or a menu, or other means of navigation known in the art.

By way of example and not limitation, the control surfaces may map to a specific decoder 22, 24, 26 or sensor 32a-h, 34, 36, 38, 40, 42. The decoder 22, 24, 26 may have control surface 302 for a first function which responds to a binary control parameter. This control parameter may be, for example, state of operation control parameter which includes the values “on” and “off.” As a part of the user interface 300, the software application may create a control surface 302 corresponding to the function and control parameter. In the case of a binary control parameter the user interface 300 may include a control surface 302 which includes two radio buttons 306, 308. A first radio button 306 may allow a user to send a command turn the system module on by selecting the first radio button 306, which is labelled “on,” and a second radio button 308 may allow a user to send a command turning the system module off by selecting the second radio button 308, which is labelled “off.”

The screen on the user interface 300 may have additional control surfaces. The control surfaces may map to the same decoder 22, 24, 26 such as where the decoder has a second function that has a control parameter which includes a range of values. For example, the range of values may be a discrete period of time in minutes. As a part of the user interface 300, the software application may create a control surface corresponding to the function and control parameter. In the case of a control parameter with a range of values, the user interface 300 may include a control surface 304 which includes a scale of values. As shown in FIG. 3, the values range from 1 to 60. However, it is understood that the values may begin at any number and may end at any number. The range of values may be more than 1-60, and the range of values may be less than 1-60. The user may slide the marker 310 along the scale 312 to each of the indexed positions in order to control the function. Thus, a user may send a command to a decoder to turn on a specified valve for a period of time using both the binary control surface and the range of values.

Similar to the decoders 22, 24, 26, the one or more sensors 32a-h, 34, 36, 38, 40, 42 connected to the irrigation system 10 may each have a screen. On each screen may be information, including what type of data the sensor 32a-h, 34, 36, 38, 40, 42 measures. As described in greater detail herein with regard to closed loop operation of portions of the irrigation system 10, the sensor 32a-h, 34, 36, 38, 40, 42 may have certain parameters which may be set which will affect the operation of the sensor 32a-h, 34, 36, 38, 40, 42. Specifically, if the sensor 32a-h, 34, 36, 38, 40, 42 takes a measurement matching set parameter value, then the sensor 32a-h, 34, 36, 38, 40, 42 may send a control signal to one or more pre-determined decoders 22, 24, 26 to control the operation of the one or more pre-determined decoders 22, 24, 26. To control these parameters, the screen may show the currently set parameters, and may have a corresponding window to change the value of each of the upper and lower limit of the parameters, as is shown in Step 204 of FIG. 2.

A user may send control signals from the user interface 300 to control one of the one or more decoders 22, 24, 26. Alternatively, or in addition, the user may send control signals from the user interface 300 to control a plurality of the decoders 22, 24, 26. In a similar way, the user may send control signals from the user interface 300 to set parameters for a plurality of the one or more sensors 32a-h, 34, 36, 38, 40, 42.

The PLC protocol is designed so that control signals include an identifier as to which of the one or more decoders 22, 24, 26 and sensors 32a-h, 34, 36, 38, 40, 42 the message is directed. Although three decoders 22, 24, 26 and thirteen sensors 32a-h, 34, 36, 38, 40, 42 are shown, it should be understood that the irrigation system 10 may have more or fewer than three decoders and/or more or fewer than thirteen sensors. If a message is not directed to a particular decoder 22, 24, 26 or sensor 32a-h, 34, 36, 38, 40, 42, that decoder 22, 24, 26 or sensor 32a-h, 34, 36, 38, 40, 42 ignores the message. The PLC protocol may further include an identifier that includes all of the decoders 22, 24, 26 and sensors 32a-h, 34, 36, 38, 40, 42. Using the identifier which includes all of the decoders 22, 24, 26 and sensors 32a-h, 34, 36, 38, 40, 42, a user may send a control signal which affects all of the decoders 22, 24, 26 and sensors 32a-h, 34, 36, 38, 40, 42, for example, for the decoders 22, 24, 26 to turn off all of the valves and to power down the sensors 32a-h, 34, 36, 38, 40, 42 in preparation for electrical or irrigation infrastructure work in the irrigation system 10. The control surfaces which affect all of the decoders 22, 24, 26 and sensors 32a-h, 34, 36, 38, 40, 42 on the irrigation system may be on a separate screen from the control surface which only affect an individual decoder 22, 24, 26 or sensor 32a-h, 34, 36, 38, 40, 42.

The computing device 12 may access the irrigation system 10 through the universal device 30, or combination controller 14 and universal device 30 which means that the universal device 30 may receive control signals sent by the computing device 12 and transmit data and acknowledgements sent by the decoders 22, 24, 26 and sensors 32a-h, 34, 36, 38, 40, 42 to the computing device 12, over either the wired or wireless connection. In addition to these communications functions, the universal device 30 performs several other functions. First, the universal device 30 converts the messages of the computing device to the PLC protocol. The universal device 30 includes instructions which allow the universal device 30 to recognize which operating system the computing device 12 is using, and establish bilateral communication with the computing device 12, for example using the IEEE 802.11 protocol. Then, when the computing device 12 sends messages, the universal device 30 converts the messages from the IEEE 802.11 protocol to the PLC protocol used for communication between the universal device 30 and the decoders 22, 24, 26 and sensors 32a-h, 34, 36, 38, 40, 42. Second, the universal device 30 provides routing functions for messages sent by the computing device 12 to the various decoders 22, 24, 26 and sensors 32a-h, 34, 36, 38, 40, 42 and between the decoders and sensors. Third, the universal device 30 provides device management. When a new decoder or sensor is added, the universal device 30 may detect the addition of the decoder or sensor and request identification information from the decoder or sensor. The identification information may include an identification code for the decoder or sensor, what functions the decoder or sensor has, and what the control parameters for the functions are. The universal device 30 may store this information in a non-transient media memory.

After the controller 14 receives the information as to the decoders 22, 24, 26 and sensors 32a-h, 34, 36, 38, 40, 42 on the irrigation system 10, the controller 14 is ready to program the irrigation system 10, as is indicated in Step 202 of FIG. 2. Watering cycles may be keyed to a schedule created in the controller 14 or on a computing device 12 connected to the controller 14. Alternatively, irrigation may be sensor-controlled, that is, rather than being set to a specific schedule, a sensor 32a-h, 34, 36, 38, 40, 42, based on data taken being outside of parameters stored in a memory on the sensor 32a-h, 34, 36, 38, 40, 42, may send a command to a decoder to open or close a predetermined valve 28a-h. The irrigation system 10 may also be controlled by a combination of scheduling and sensor-based operation.

Initial set up may include providing data to sensors 32a-h, 34, 36, 38, 40, 42. Data storage may need to be assigned for data being sent by any sensors 32a-h, 34, 36, 38, 40, 42 on the irrigation system 10. How much historical data to be retained may have to be determined. The setting of a cut-off date for historical data may cause the controller 14 to erase any older data from memory. Of course, this will not occur immediately at set up, but rather will occur once the irrigation system 10 has operated long enough to reach the cut-off date. The controller 14 or computing device 12 may be used to send parameters to the sensors 32a-h, 34, 36, 38, 40, 42, as is shown in Step 204 of FIG. 2. For example, based on the type of sensor 32a-h, 34, 36, 38, 40, 42, parameters may be set which indicate a condition which requires no action, but if data is taken which is outside those parameters, then the sensor 32a-h, 34, 36, 38, 40, 42 may be programmed by the controller 14 with a command to send to one or more decoders 22, 24, 26. The operation of the irrigation system 10 where the sensors 32a-h, 34, 36, 38, 40, 42 control the decoders 22, 24, 26 may be referred to as closed-loop operation. If the decoder 22, 24, 26 receives a command from either the controller 14 or one of the sensors 32a-h, 34, 36, 38, 40, 42, the decoder 22, 24, 26 sends an acknowledgement to the device from which the command originated. If the device, either the controller 14 or a sensor 32a-h, 34, 36, 38, 40, 42, does not receive an acknowledgement, the device may resend the command after a predetermined time interval, and repeat the cycle until an acknowledgement is received.

The sensors 32a-h, 34, 36, 38, 40, 42 may also have a parameter for data volume. For example, a sensor 32a-h, 34, 36, 38, 40, 42 could send data every tenth of a second, every second, every half minute, every minute, every hour, or at any interval. There is no system limitation on the amount of data which may be sent by a sensor 32a-h, 34, 36, 38, 40, 42. However, as a practical matter, many of the types of measurements the sensors 32a-h, 34, 36, 38, 40, 42 may take may change very little in short periods of time. Thus, it would be impractical to take data which only serves to reinforce itself, and not to track changes. Thus, each sensor 32a-h, 34, 36, 38, 40, 42 may be programmed with an individual time interval which may correspond to the timing that the data may change.

The controller 14 may be programmed with a weekly or monthly schedule for controlling the irrigation and fertilization, if any is present, through the decoders' operation of the valves 28a-h. In addition, some sensors 32a-h, 36 may serve to primarily monitor the operation of the irrigation system 10 itself. For example, flow sensors 36 may provide data about the flow of water or liquid fertilizer through the irrigation system 10, collecting simple binary data such as whether flow is present or absent. Other sensors may provide more fidelity. For example, the controller 14 may send a command to one of the decoders 22, 24, 26 to open a valve 28a-h, as is shown in Step 206 of FIG. 2, a pressure sensor 32a-h may provide pressure measurement data in a portion of the line on the far side of a valve 28a-h controlled by the decoder 22, 24, 26. The pressure data may have a baseline established through an initial time period of operation. Measurements outside of an established baseline range may be indicative of a problem with the irrigation system 10. For example, a low pressure measurement may be indicative of a broken sprinkler head or a beak in the pipe of the line itself. A high pressure measurement may be indicative of an obstruction in the line. For example, the obstruction may be a sprinkler head not operating. The sprinkler head may not be operating because the mechanism is stuck despite the flow of water to the sprinkler head. The ground covered by the sprinkler head is not being irrigated and could be damaged by the lack of irrigation.

Current sensors may be used to monitor the operation of the control system itself. For example, a current sensor may be placed at a predetermined location along the electrical path. If the two-wire path is no longer conducting as designed, the current sensor immediately upstream of the location of the problem will give the user a more precise location to search for the source of the problem. If a sensor is no longer sending data to the controller 14, but current sensors downstream on the electrical path are still sending current data to the controller 14, it may be an indication that the sensor no longer sending data has failed. The user may then go to that location and replace the current sensor. The current sensors may be placed in a box along with a decoder. Current sensors may be placed with the decoder regardless of the distance from the previous current sensor. Alternatively, a current sensor may be integrated with the decoder. This decoder/current sensor combination would provide sensor data at the predetermined time interval in addition to performing other decoder functions as described herein. The current sensor may itself be programmed with parameters and send data to the controller indicating an out of parameter condition. The controller may include instructions to alert a user via none, or any combination of a displayed alarm, an audible alarm, or passing data to the computing device to trigger an alarm on the computing device. Alternatively, the current sensors may simply send data to the controller 14, and the controller 14 stores the parameters, and either provide an alarm, or pass an alarm to a computing device 12 when there is an out of parameter condition. The controller 14 may store the current sensor data in a database as with other sensors described herein. Alternatively, the controller 14 may not store any of the current data, only monitoring the current sensor data as it is provided by the current sensors.

The current sensors, working in combination with the decoders, or the decoders alone, may aid in trouble shooting. The current sensor and decoder combination may further include a relay. The relay allows a user to cut the electrical signal at any decoder. The cutting of the signal would allow for a user to determine if current flow is as expected to that point in the irrigation system 10. The relay may be used to cut the signal at each decoder in turn in order to determine which decoder is experiencing a problem. It is typical that the decoders in an irrigation system are much more likely to fail than the wiring, unless there has been ground work done in the area of the system. However, when it is the case that ground work has been done in the area of the irrigation system 10, it will be apparent where the damage to the wires might be, making trouble shooting much easier. Where the current sensors find an atypical current load, the likely cause is a bad decoder. The relays may be connected to the decoder and operated by PLC protocol through the decoder. In some embodiments, the irrigation system 10 may include a decoder, a current sensor, and a relay. In some embodiments, the current sensor may be integrated with the decoder. Some embodiments may include only a decoder and a current sensor.

Each decoder may have a self-assigned address for use in communication, and, by extension, trouble shooting. The address may be created as part of the identification information requested by the universal device 30 or controller 14 and sent from the decoder or sensor to the universal device 30 or controller 14 as described herein. For example, the address may be a predetermined number of digits. This example will use three digits, but it is understood that the address may be fewer than three digits or more than three digits. The decoder or sensor may include a random number generator. The random number generator may run for each digit, or it may run for the entire number. Specifically, the random number generator may run for each digit, randomly determining a digit between 0 and 9. Alternatively, the random number generator may be programmed to provide a number between 0 and 99 if the address is two digits, or 0 and 999 if the address is three digits, and so on, up to any number of digits to be used for the address.

After the universal device 30 or controller 14 receives all of the addresses, the universal device 30 or controller 14 runs a conflict check among the addresses. That is, the universal device 30 or controller 14 checks each address against the others to determine if there are any duplications. If there are no duplications, the universal device 30 or controller 14 accepts the addresses. If there is a duplication, then the universal device 30 or controller 14 sends a command to the decoder or sensor associated with one of the duplicate addresses a command to determine a new address. The decoder or sensor runs the random number generator again and sends the resulting address back to the universal device 30 or controller 14, which repeats the conflict check. Additional repeats of the cycle occur if further duplicate addresses are found. After no duplicate addresses are found, the universal device 30 or controller 14 accepts the addresses. This auto addressing protocol cannot be used by typical systems due to the slow data rates. The addressing algorithm would take too long to be practicable. Thus, typical systems are required to use an address assigned at the factory or manual addressing schemes.

The controller 14 may include a feature which maps the addresses. For example, once all the individual addresses are accepted, the controller 14 may provide a map of the decoder and sensor locations with the corresponding address of the decoder or sensor represented on the screen. For example, after installation, a smart phone's GPS feature may be used to provide GPS coordinates to the controller 14 for the decoder or sensor. The decoders and sensors may include a feature which allows a user to double check the address. Using the computing device 12, such as a smart device, in communication with the irrigation system 10, using the address, the user may be able to send a command to the decoder or sensor to emit a tone. The decoder or sensor may include a speaker or equivalent component which is electrically connected to the processor of the decoder or sensor. The decoder or sensor corresponding to the address entered by the user emits the tone. This feature may be used to confirm the location of the decoder or sensor for map creation. This feature may also be used to confirm that the user has located the correct decoder or sensor during troubleshooting. For example, the tone may be used to determine another decoder's location to ensure that a non-responsive decoder's location is correct.

The irrigation system 10 may be programmed to alert a user of an error condition. The sensor 32a-h, 34, 36, 38, 40, 42 may send data indicating out-of-parameter data to the controller 14. The controller 14 may display an error condition with the line. The controller 14 may further emit an audible alarm. The controller 14 may emit only the audible alarm. Regardless of the particular method, the controller 14 uses an alert to inform a user of the error condition. Alternatively, or in addition, if a computing device 12 is connected to the controller 14, the controller 14 may send an error message to the computing device 12. Depending on the software, the computing device 12 may display an alarm message, may emit an audible tone which warns the user of the error condition, or both. If the computing device 12 has the capability, the application may cause the computing device 12 to vibrate to alert the user of the error condition.

The schedule may be created as a baseline meant to be supplemented based on sensor operation. For example, the irrigation system 10 may include soil moisture sensors 34, 42 which are placed in strategic locations around the area to be irrigated. The area may include at least one low lying area where irrigation tends to accumulate. The area may also include at least one portion which is sloped such that irrigation largely runs off of that area before the irrigation can be absorbed. Moisture sensors 34, 42 may be placed in the soil in those locations. The moisture sensor 34, 42 may prevent the schedule from operating in the low area if there is an accumulation of moisture in the soil. As is shown in Step 208 of FIG. 2, in the run-off area, the moisture sensor 34, 42 may send a command to the decoder 22, 26 to turn on the valve 28a-c, 28g, 28h, even when that zone of sprinkler heads is not scheduled to run, in order to provide enough moisture for that area to maintain the flora contained within. Thus, the irrigation system 10 is capable of autonomous customization. The schedule provides the baseline, with the controller 14 operating the irrigation system 10 in open-loop operation, but individual sensors 32a-h, 34, 36, 38, 40, 42 may provide customization on top of the baseline schedule for areas covered by the irrigation system 10 that have irrigation requirements which differ from the baseline. Moreover, this customization is not programmed beyond proving parameters to the sensors 32a-h, 34, 36, 38, 40, 42. As shown in Step 208 of FIG. 2, if data is taken by the sensors 32a-h, 34, 36, 38, 40, 42 which is outside the stored parameters, the sensor 32a-h, 34, 36, 38, 40, 42 sends a command to the decoder 22, 24, 26 to either turn the valve 28a-h on, or to keep the valve 28a-h closed, depending on which side of the parameters the data falls. Thus, the disclosed irrigation systems provide open-loop operation, closed-loop operation, and hybrid operation which includes a combination of both open- and closed-loop operation.

The irrigation system 10 may have sensors 40 for monitoring the levels of fertilizer in the area. As with the irrigation of water alone, liquid fertilizer may be delivered by at least some of the same irrigation infrastructure. The fertilizer may also be combined with herbicides or pesticides, or both, to keep unwanted plant life or insects at bay while growing the wanted plant material. The herbicides may be stored in a vessel or tank separate from the fertilizer. Similarly, the pesticides may be stored in a vessel or tank separate from the fertilizer. Alternatively, they may all be stored in a single tank with fully segregated baffles, and separate output valves controlled by the controller 14, and if one is connected, a computing device 12 for each baffle. The piping infrastructure of the irrigation system 10 may carry each to a common pipe. Flow rates may be controlled by programming the controller 14, or by a sensor, or both. Because each of the fertilizer, herbicide, and pesticide use water as a delivery vehicle the irrigation system 10 may choose to deliver water and one of each of the fertilizer, herbicide, and pesticide at a time. This may be necessitated by potential chemical interactions between the fertilizer, the herbicide, and the pesticide. The controller 14 may include a table of flow rates which may be installed at the factory when the controller 14 is manufactured, but editable by a user, or may be input by the user. Based on the stored flow rates, the decoders 22, 24, 26 may control the valves for the liquid fertilizer, the herbicide, and the pesticide in order to achieve the correct mix with the water flow. Again, water flow and pressure sensors may be used to determine the amount of water flowing through any point in the irrigation system 10. The same may be used for the liquid fertilizer, the herbicide, and the pesticide, each of which may also be termed an additive, if the flow through the valve cannot be determined based on the product put in the tank and the amount the valve is open. The irrigation system 10 may also include an intermediate tank where the water and additive are mixed to a known concentration, and then distributed to sprinkler heads for application.

The irrigation system 10 may include one or more rain gauge sensors. Similar to other sensors 32a-h, 34, 36, 38, 40, 42, upon initial programming, the controller 14 or a computing device 12, if one is connected, may be used to provide parameters to a rain gauge sensor. These parameters may be altered at some time after initial programming. The parameters may include a rain amount and a period of time. Based on exceeding these parameters, the rain gauge sensor may send data or a command to the controller 14. Based on the data or command the controller 14 may suspend all operation of the irrigation system 10 for a predetermined period of time. Alternatively, the controller 14 may suspend operation of the irrigation system 10 until a moisture sensor 34, 42 on the irrigation system 10 sends data to the controller 14 indicating that the moisture level has dropped below a parameter. Based on the moisture data from the moisture sensor 34, 42, the irrigation system 10 may resume operation based on an irrigation schedule stored in the controller 14.

The irrigation system 10 may alter an irrigation schedule stored in the controller 14 based on measurements of temperature and humidity. The irrigation system 10 may include a temperature sensor, a humidity sensor, or a combination temperature and humidity sensor 38, or both a temperature sensor and a humidity sensor. The temperature data and the humidity data may be used separately, or the data may be used in a combined manner, for example, to determine a heat index. Similar to other sensors, parameters may be loaded on to, and stored in a memory of, a temperature sensor, a humidity sensor, or a combination temperature and humidity sensor 38. An algorithm may also be stored on the memory and executed on a processor on the sensor which causes the sensor to send a command or data when a measurement is taken that is outside of the stored parameters. The command or data may be sent to the controller 14, one or more decoders 22, 24, 26, or both. For example, on a combined temperature and humidity sensor 38 there may be an algorithm stored on the memory and executing on the processor of the sensor 38 which uses both the temperature and humidity data to produce a heat index value. Parameters for the heat index value may also be stored on the memory of the sensor 38. If the algorithm produces an index value which is outside of the parameters, the sensor 38 may send a command to a decoder 22, 24, 26 and data to the controller 14 for opening one or more valves to provide additional water due to excessive heat. The data sent to the controller may be recorded in a database. The data may be used by an algorithm to provide suggested seasonal programming for the irrigation system 10. The algorithm may suggest a more frequent irrigation schedule during the summer, for example.

### Example Transceiver

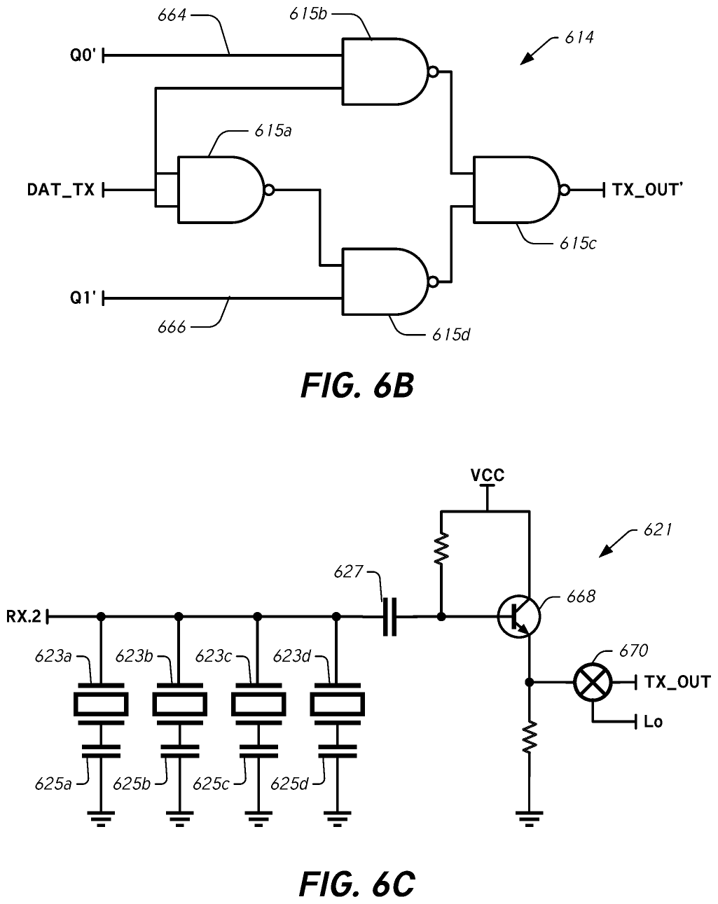

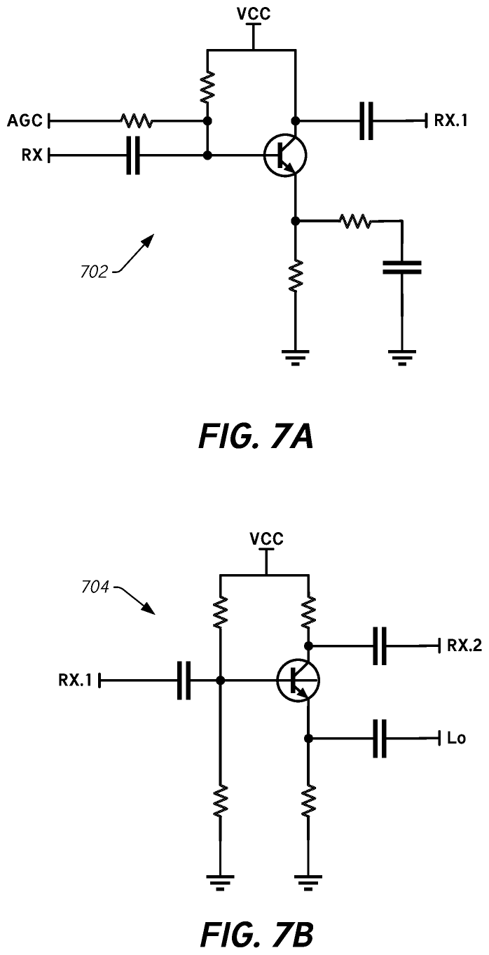

FIG. 4 illustrates an example transceiver 400 that may be incorporated into the controller 14 and/or the universal device 30. Transceivers may also be incorporated in individual decoders 22, 24, 26 and/or individual sensors 32a-h, 34, 36, 38, 40, 42. The transceiver 400 includes a coupling circuit 500, a transmitter portion 402, a receiver portion, and optionally a transformer 406. The transceiver 400 couples to the two-wire electrical path to send and receive signals to the components of the irrigation system that are coupled to the two-wire electrical path. The transceiver 400 is configured to convert command signals to be able to transmit the command signals using power line communication protocols that utilize ultra-narrowband signals. Examples of the coupling circuit 500 are described in greater detail herein with reference to FIG. 5. Examples of the transmitter portion 402 are described in greater detail herein with reference to FIGS. 6A-6C. Examples of the receiver portion are described in greater detail herein with reference to FIGS. 7A-7E.

Power is taken from the two-wire electrical path or a power line and transformed by the transformer 406 to a targeted voltage. The power may also be converted to a desired form of current (e.g., from alternating current (AC) to direct current (DC)). The voltage may be transformed down, for example, from 110 V to 5 V.

### Example Coupling Circuit

FIG. 5 illustrates an example coupling circuit 500 that is part of the transceiver 400. After voltage regulation, the signal may pass through one or more coupling circuit filtering stages 506a, 506b. The filtering stages 506a, 506b may include a circuit with one or more resisters and one or more capacitors, commonly known as an RC circuit. These RC circuits 506a, 506b may form an RC network which filters out certain frequencies within a bandwidth. Thus, while the transformer 502 acts as a high pass filter, the RC network, which is the combination of the RC circuits 506a, 506b acts as a band pass filter. The band pass filtering of the RC network 506a, 506b augments the filtering of the ultra-narrowband filter in the receiver portion of the transceiver. The ultra-narrowband filter is also a band pass filter. Thus, the Q factor of the combined coupling circuit and ultra-narrowband filter in the receiver portion may be an order of magnitude higher than the Q factor would be for the ultra-narrowband filter alone. By raising the Q factor, the system is able to provide better reception of control signals due to band passing a frequency band so narrow it includes the one or more frequencies of the control signal and little to nothing else. The noise present on frequencies not band passed is greatly suppressed.

Further, the RC network 506a, 506b may be changed if further filtering is required. Thus, the ultra-narrowband filter may not need to have such a high Q factor in embodiments where the coupling circuit 500 has augmented filtering. Alternatively, the RC network 506a, 506b can be changed depending on the transmission frequency. For example, in embodiments where a lower frequency and more phase states are chosen for the control signal, the RC network may be different than the RC network of an embodiment with a higher transmission frequency and fewer phase states are used to form the control signal.

### Example Transmitter

The transceiver 400 includes a transmitter portion 402. The transmitter 402 includes a plurality of sub-circuits. The transmitter portion 402 may include a crystal oscillator circuit 610, an example of which is illustrated in FIG. 6A. The crystal oscillator circuit 610 draws power from the power line. Each of two crystal oscillators may output a signal. The first crystal oscillator may have a first predetermined primary frequency and amplitude. The second crystal oscillator may have a second predetermined primary frequency and amplitude, with the second primary frequency being a multiple of the first primary frequency. In the example of FIG. 6A, a first crystal oscillator circuit 611 produces a signal that is split to form the two sinusoidal waves for forming the control signal. The second crystal oscillator circuit 660 provides a clock signal. The clock signal may be used to control the amount of phase shifting. For example, if a crystal oscillator of 1 MHz is used to produce the signals for transmission, the crystal oscillator for the clock signal may be a multiple of 4 MHz. For example, the crystal oscillator producing the clock signal may be 16 MHz. Based on the ratio, the transceiver may produce as many as 15 phase-shifted signals of the 1 MHz signal, using the 16 MHz clock signal, as is described in further detail herein. One or more of the phase-shifted signals, along with the original signal, may be used to encode information, as is described in further detail herein. As long the crystal oscillators receive power, the crystal oscillators continue to output a signal.

Crystal oscillators emit a sinusoidal wave at a frequency determined by their physical structure. Advantageously, crystal oscillators, and particularly quartz crystal oscillators, have a very high Q factor. Quartz crystal oscillators are capable of primary frequencies from in the high kHz up to the MHz range. However, higher frequency signals, up into the GHz range, may be produced by amplifying a harmonic of the primary frequency. Further, this disclosure also contemplates using amplified harmonics of the oscillator, and even potentially frequency modulated amplified harmonics, to allow transmission frequencies as low as 1 Hz. Also, as indicated by the high Q factor, they have a narrow bandwidth relative to their frequency. A typical Q factor for a quartz oscillator ranges from 10⁴ to 10⁶, compared to 10² for an inductor and capacitor, or LC, oscillator. The maximum Q for a high stability quartz crystal oscillator can be estimated as Q=1.6×10⁷/f, where f is the resonant frequency in megahertz.

Another beneficial aspect of quartz crystal oscillators is that quartz crystal oscillators exhibit very low phase noise. In many oscillators, any spectral energy at the resonant frequency is amplified by the oscillator, resulting in a collection of tones at different phases. In a crystal oscillator, the crystal mostly vibrates on one axis, therefore only one phase is dominant. Low phase noise makes crystal oscillators particularly useful in applications requiring stable signals and very precise time references. This is particularly advantageous with this disclosure as the signal from one of the crystal oscillators may be phase shifted by a targeted amount. In some implementations, for improved operation of the system, the phase shift between the two signals is consistent, as is discussed herein in greater detail.

A quartz crystal provides both series and parallel resonance. The series resonance is a few kilohertz lower than the parallel resonance. Crystals below about 30 MHz are generally operated between series and parallel resonance, which means that the crystal appears as an inductive reactance in operation, this inductance forming a parallel resonant circuit with externally connected parallel capacitance. Any small additional capacitance in parallel with the crystal pulls the frequency lower. Moreover, the effective inductive reactance of the crystal can be reduced by adding a capacitor in series with the crystal. This latter technique can provide a useful method of trimming the oscillatory frequency within a narrow range; in this case inserting a capacitor in series with the crystal raises the frequency of oscillation. For a crystal to operate at its specified frequency, the electronic circuit has to be exactly that specified by the crystal manufacturer. Note that these points imply a subtlety concerning crystal oscillators in this frequency range: the crystal does not usually oscillate at precisely either of its resonant frequencies.

Crystals above about 30 MHz (and even up to >200 MHz) are generally operated at series resonance where the impedance appears at its minimum and equal to the series resistance. For these crystals, the series resistance is specified (<100Ω) instead of the parallel capacitance. To reach higher frequencies, a crystal can be made to vibrate at one of its overtone modes, which occur near multiples of the fundamental resonant frequency. Only odd numbered overtones are used. Such a crystal is referred to as a 3rd, 5th, or even 7th overtone crystal. To accomplish this, the oscillator circuit may include additional LC circuits to select the desired overtone.

Crystal oscillators may experience frequency drift over time. Thus, the system may include a frequency correction circuit to compensate for this frequency drift. The frequency modulation circuit may include an ability to detect the incoming signal and provide data on the frequency of the incoming signal to a processor. The processor may be connected to a memory which stores data on an expected frequency for the signal, and instructions which may be executed on the processor to control the frequency modulation circuit to modulate the incoming signal either up or down to match the expected frequency if the incoming signal is not at the expected frequency. The frequency modulation circuit may extend the operable life of the quartz crystal oscillator by compensating for the expected eventual frequency drift.

A signal from the first crystal oscillator circuit 611 is routed to an integrated circuit 616. Between the first crystal oscillator circuit 611 and the integrated circuit 616, the signal may be split to create two signals. The signal may be split at a location between the crystal oscillator circuit and the integrated circuit 616. The crystal oscillator circuit may be a complementary metal oxide semiconductor (CMOS) crystal oscillator circuit. Alternatively, the crystal oscillator circuit may be an alternate type of oscillator circuit, with oscillator circuits which operate in series resonance providing some advantages. The split signal may be input, each on a separate pin, to the integrated circuit 616. The signal is input to the integrated circuit 616 on two pins, pin A and pin B. The integrated circuit 616 may include a phase shift sub-circuit to phase shift one of the input signals. It will be easily recognized by those of ordinary skill in the art that the integrated circuit 616 may include a plurality of phase shift sub-circuits in order to create a plurality of phase shifted signals from at least one of the two input signals. At least one of the two split signals input from the first crystal oscillator circuit to the integrated circuit 616 may pass through the integrated circuit 616 without modification to the amplitude, frequency, or phase of the signal. Moreover, all of the signals, including those that are phase shifted, retain the same frequency.

The signals input on pin A may have a different signal path from the signal input on pin B. For example, the signal input on pin B may pass through a phase shift circuit, and the signal input on pin A passed without passing through a phase shift circuit. Alternatively, the signal from pin A may be phase shifted, and the signal input on pin B may pass without the phase being changed. The integrated circuit 616 may phase shift the second signal many times. For example, using the clock signal of 16 MHz to index the timing of the phase shifts of the 1 MHz signal, the signal may be phase shifted as many as 15 times. This is because 16/1=16. That is, there are 16 possible phase states, or the original state and 15 shifted states in each cycle of the 1 MHz signal which are indexed by the 16 MHz clock signal. The 16 MHz clock signal is produced by a 16 MHz crystal oscillator circuit 660, and input to the clock pin of the integrated circuit 616. Thus, each of the 15 phase shifted signals may be shifted by 22.5 degrees because 360/16=22.5. As discussed herein, the frequency oscillation of a crystal oscillator is very stable and accurate. The phase shifting circuit of the present disclosure makes use of this stability and accuracy of the clock frequency crystal oscillator, which is 16 MHz in this example, as a tool in phase shifting. Because the phase shift circuit indexes the phase shift based on the stable and accurate frequency of the clock crystal oscillator, the phase shifts of the transmission frequency signal are very precise. This precision provides the potential for the use of multiple phase states to create higher data rates.

As discussed herein, there may be up to 16 different phase states in certain embodiments. Depending on the crystals used, there may be more than 16 or less than 16 possible phase states. Each of the phase states may be assigned to represent one of two binary states, that is, one or zero. While these phase states may be produced, the system may choose to utilize less than all the phase states that are produced. In the simplest embodiment, the system may use just the unaltered signal and one phase shifted signal.

The phase-shifted signal may then be routed to one terminal of a switch 614, an example of which is illustrated in FIG. 6B. The switch 614 may be a combination of logic gates 615a-d, for example not/and (NAND) gates, a fast switching operation, as is well known in the art, or any other switch which is able to provide fast enough switching, including transistors which may act as switches by having a voltage applied to, and then disconnected from, the base of the transistor. The switch 614 may have the general effect equivalent to that of a single pole, dual throw, or SPDT switch. The first of the two incoming signals from the first crystal oscillator of FIG. 6A may be connected to a first terminal 664 of the switch 614. The second of the two incoming signals from the one or more crystal oscillators of FIG. 6A may be connected to a second terminal 666 of the switch 614. The output may be connected to the common of the switch 614. The speed of the switch 614 allows for very rapid alternation between the first signal and the phase shifted second signal. By way of example and not limitation, the switch 614 may cycle fast enough to switch 10 times from the first signal to the second signal and back to the first signal in a single cycle of a 40 MHz signal. Thus, there is an opportunity, depending on the protocol used by the system, to send 10 bits of information in a single 40 MHz cycle, all without interference by noise. In this example, the system could generate 400 million bits of information a second on a bandwidth of a single frequency. Alternatively, the switch may cycle fewer than 10 times in a 40 MHz cycle, or more than 10 times in a 40 MHz cycle. Still further alternatively, the crystal oscillator may generate a sinusoidal wave at more than 40 MHz or less than 40 MHz. The operation of the system, including the creation and switching between the sinusoidal waves produced by the crystal oscillators is discussed in greater detail herein.

It will be apparent to one of ordinary skill in the art that the components of the switch may be expanded to allow for the formation of a control signal with any plurality of phase states. While the example shown includes only two logic gates for the passage of the signals to two phase states, one of ordinary skill in the art will recognize that the configuration of switch 614 can be expanded to accommodate many more phase states. For example, even 100 or more phase states may be possible. When designing an embodiment for a plurality of phase states to encode information on a control signal, a balance may be struck between the frequency of the transmission signal and the number of phase states. For example, when lower frequencies are used, more phase states may be used, and when higher frequencies are used, fewer phase states may be used. This is only a general rule, and other factors may cause exceptions.

Before the control signal is transmitted, the control signal may be routed through a harmonic elimination and frequency mixing circuit 621, an example of which is illustrated in FIG. 6C. The circuit 621 may include a plurality of crystal oscillators 623a-d and capacitors 625a-d in parallel. The control signal passes through one capacitor 627 in series, and then through a transistor 668. Finally, the control signal passes through a signal lamp 670 and is output.

### Example Receiver

The transceiver 400 includes a receiver portion 404. The receiver 404 includes a plurality of sub-circuits. As shown in FIG. 7A, a received control signal may first pass through a high frequency amplification sub-circuit 702 of the receiver. As shown in FIG. 7B, a mixing and amplification sub-circuit 704 may be connected to the high frequency amplification sub-circuit 702. As shown in FIG. 7C, connected to the mixing and amplification sub-circuit 704 is an ultra-narrowband filter 706. The ultra-narrowband filter 706 passes a very narrowband of frequencies, for example, 10 Hz. Just as with the crystal oscillator in the transmitter portion 402 of the transceiver 400, the crystal in the ultra-narrowband filter 706 has a very high Q factor. The crystal's stability and its high Q factor allow ultra-narrowband filters 706 to have precise center frequencies and steep band-pass characteristics. Thus, the ultra-narrowband filter only captures frequencies in an ultra-narrowband centered on the frequency produced by the crystal oscillator circuit 610 and does not allow the rest of the signal on the power line to pass to the transceiver 400. Thus, the power signal on the power line may be routed to other components in the device to provide power, with the power signal being substantially unaffected. As shown in FIG. 7D, the ultra-narrowband filter 706 is connected to an amplitude limiting sub-circuit 708. A control signal passing through the amplitude limiting sub-circuit has the amplitude controlled because too high amplitude in the control signal can cause distortion in the control signal when the control signal is decoded. As shown in FIG. 7E, the amplitude limiting sub-circuit 708 may be connected to a baseband decoder sub-circuit 710. As explained in further detail herein, the baseband decoder sub-circuit 710 may receive the analog signal with varying phase states, and the protocol may be used to measure the phase states against a clock signal as a standard or index. The baseband decoder sub-circuit 710 uses one or more integrated circuits 712, 714 to convert the control signal into a binary baseband signal. After conversion, the decoded baseband signal is amplified by an operational amplifier 716 and output.

### Example Control Signal

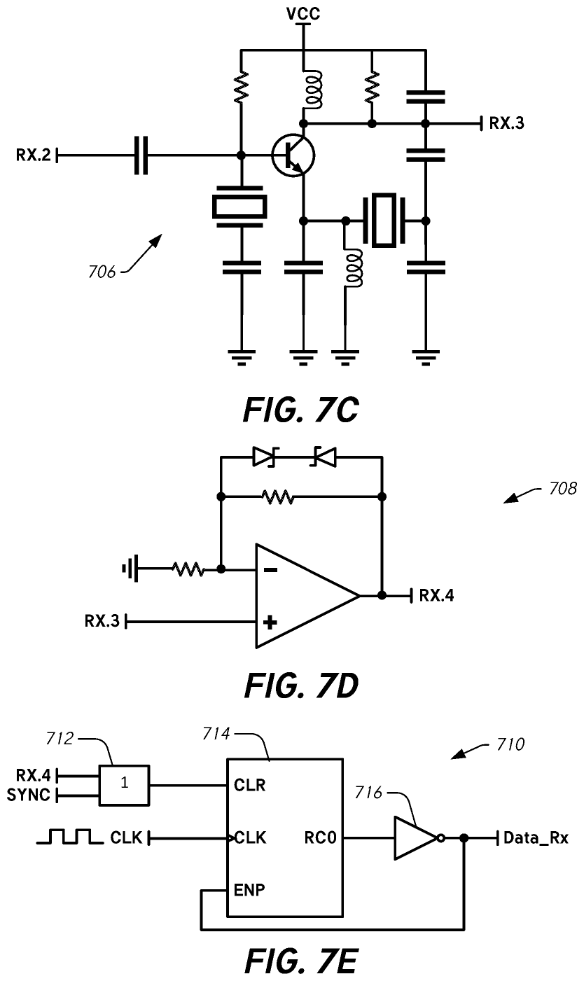

To send commands over the two-wire electrical path, commands can be converted to control signals by the protocols described herein. The control signal has two parts. The first part is the sinusoidal wave, which the crystal oscillation circuit 610 generates continuously. The second part is a sinusoidal wave with a shifted phase. After generation, the sinusoidal wave is fed to the phase shift circuit within the integrated circuit 616 to create the second signal, and to the switch 614, as described herein. The output of the phase shift circuit is input to a different terminal of the switch than the unaltered first signal or sinusoidal wave. FIG. 8 illustrates the two signals arriving at the switch and includes the first signal 810 and the phase-shifted second signal 812. In addition to being connected to the oscillator and the phase shift circuit, the switch 614 is also connected to a processor which executes the protocol by providing a baseband signal to the switch 614. Based on the command signals from the controller (e.g., the controller 14), which are converted by the processor using the protocol, the processor directs the switch 614 to switch between the first signal and second signal according to the baseband signal to encode a control signal. Information is encoded by the presence of one or the other of the first signal and the second signal. The first signal my represent one binary state, that is, a one or a zero, and the second signal may represent the other binary state. It will be readily understood by those of ordinary skill in the art that signals of still differing phase states may be created by adding phase shift circuits which shift the phase of the sinusoidal way differing amounts. By way of example and not limitation, there could be five phase shift circuits, which generate signals with five different phase states. Including the original signal, six phase states are represented. Each phase state may be assigned to represent a binary state. Sequences of data, encoded with binary bits or otherwise, may form a control signal that can be analyzed and decoded by the protocol.

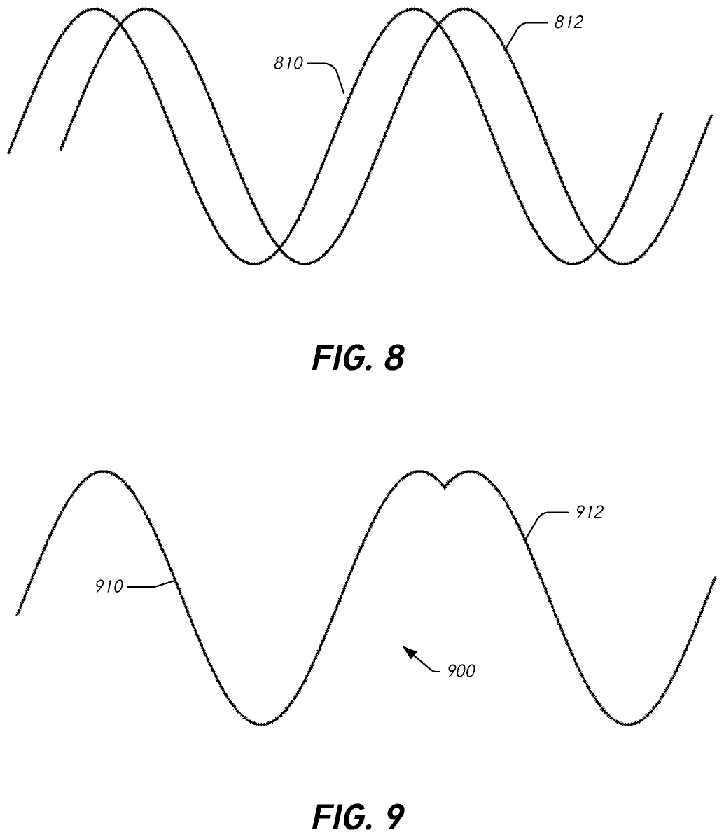

Once the control information is encoded by creating the control signal, the control signal is output to a filter circuit 621, which filters out sideband signals with a series of local oscillators 623a-d and capacitors 625a-d, as described herein. FIG. 9 illustrates an example control signal 900. The control signal 900 includes changes of phase as the switch alternates between signals. This is shown in the control signal 900 wherein the control signal is a result of switching between the first signal 910 and the phase-shifted second signal 912.

On the receiving end, the control signal 900 is received first on the coupling circuit and may be filtered within the coupling circuit as described herein. Next, the control signal is passed from the coupling circuit to the receiving circuit, and, specifically, the ultra-narrow band filter 706 of the receiver. The ultra-narrow band filter may filter out a bandwidth of about 50 Hz or less that is centered on the transmission frequency of the crystal oscillator from the signal on the power line. Naturally, the rest of the signal on the power line is unaffected by the ultra-narrow band filter so that the power on the power line may be used to power decoders, sensors, or other elements on the irrigation system. The 50 Hz or less bandwidth captures the control signal because the phase shifts do nothing to spread the bandwidth of the original sinusoidal wave generated by the crystal oscillator. That is to say, as discussed herein, the signal is not frequency modulated.

### ADDITIONAL EMBODIMENTS

The processors described herein are configured to control operation of the components and the data store. The one or more processors implement and utilize the software modules, hardware components, and/or firmware elements configured to control and operate irrigation systems. The one or more processors can include any suitable computer processors, application-specific integrated circuits (ASICs), field programmable gate array (FPGAs), or other suitable microprocessors. The one or more processors can include other computing components configured to interface with the various modules, components, and data stores.

The memory or data store described herein is configured to store configuration data, analysis parameters, control commands, databases, algorithms, executable instructions (e.g., instructions for the one or more processors), and the like. The data store or memory can be any suitable data storage device or combination of devices that include, for example and without limitation, random access memory, read-only memory, solid-state disks, hard drives, flash drives, bubble memory, and the like.

The detailed description set forth herein in connection with the appended drawings is intended as a description of example embodiments of two-wire irrigation control systems and methods and is not intended to represent the only forms in which it can be developed or utilized. The description sets forth the functions for developing and operating the system in connection with the illustrated embodiments. It is to be understood, however, that the same or equivalent functions may be accomplished by different embodiments that are also intended to be encompassed within the scope of the present disclosure. It is further understood that the use of relational terms such as first, second, distal, proximal, and the like are used solely to distinguish one from another entity without necessarily requiring or implying any actual such relationship or order between such entities.

The above description is given by way of example, and not limitation. Given the above disclosure, one skilled in the art could devise variations that are within the scope and spirit of the subject matter disclosed herein, including various ways of using sensors to control the operation of the system. Further, the various features of the embodiments disclosed herein can be used alone, or in varying combinations with each other and are not intended to be limited to the specific combination described herein. Thus, the scope of the claims is not to be limited by the illustrated embodiments.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general-purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general-purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A system for irrigating an area, comprising:
a controller including a first processor electrically connected to a first PLC transceiver, the transceiver including at least one crystal oscillator, and a first memory electrically connected to the first processor, the memory including instructions for a PLC protocol using a data rate in excess of 10000 bits per second;
a universal device electrically connected to the controller, the universal device including an IEEE 802.11 protocol transceiver and a second PLC transceiver, a second processor, and a second memory storing a first copy of the PLC protocol;
at least one decoder electrically connected to the controller, the decoder including a third PLC transceiver, a third processor, and a third memory storing a second copy of the PLC protocol; and
at least one sensor electrically connected to the controller and one or more of the at least one decoder, the at least one sensor including a fourth PLC transceiver, a fourth processor, and a fourth memory storing a third copy of the PLC protocol;
wherein, when the system is powered, the universal device is configured to request identification information from the at least one decoder and the at least one sensor using the first copy of the PLC protocol stored on the second memory and executing on the second processor, the at least one decoder receives the request and sends the identification information using the second copy of the PLC protocol stored in the third memory and executing on the third processor, the at least one sensor receives the request and sends the identification information using the third copy of the PLC protocol stored in the fourth memory and executing on the fourth processor, and the controller uses the identification information to create software for a user to control the at least one decoder and the at least one sensor using the controller.

2. The system of claim 1, wherein the controller sends commands to either one or more of the at least one decoder, one or more the at least one sensor, or both, and the one or more the at least one decoder, the one or more of the at least one sensor, or both send an acknowledgement of the command to the controller.

3. The system of claim 1, wherein the at least one sensor sends a command to one or more of the at least one decoder.

4. The system of claim 1, wherein the PLC protocol includes instructions to only encode information on a frequency above 10000 Hz.

5. The system of claim 1, wherein each of the at least one decoder controls one or more valves.

6. The system of claim 1, wherein the at least one sensor is a pressure sensor, a moisture sensor, or an electrical conductivity sensor.

7. The system of claim 1, wherein the PLC protocol uses phase shift keying.

8. A method for operating an irrigation control system, comprising:
connecting one or more decoders to a controller via a wired connection;
programming an irrigation schedule on the controller;
adding parameters to one or more sensors in electrical communication with the controller;
sending commands, using a power line communication protocol, from the controller to the one or more decoders to operate one or more valves; and
sending commands based on the parameters, using a power line communication protocol, from the one or more sensors the one or more decoders to operate the one or more valves.

9. The method of claim 8, wherein when the one or more decoders are connected to the controller, control surfaces for controlling the one or more decoders are autonomously created on the controller.

10. The method of claim 8, further comprising sending data from the sensors to the controller, the data being stored in a memory on the controller.

11. The method of claim 8, wherein the power line communication is controlled by a protocol which operates in excess of 10000 bits per second.

12. The method of claim 8, wherein the one or more sensors include a pressure sensor, a rain sensor, and a soil moisture sensor.

13. A system for controlling an irrigation system, comprising:
a controller including a first processor electrically connected to a first PLC transceiver, the transceiver including at least one crystal oscillator, and a first memory electrically connected to the first processor, the memory including instructions for a PLC protocol using a data rate in excess of 10000 bits per second;
at least one decoder electrically connected to the controller, the decoder including a second PLC transceiver, a second processor, and a second memory storing a copy of the PLC protocol; and
at least one sensor electrically connected to the controller and one or more of the at least one decoder, the at least one sensor including a third PLC transceiver, a third processor, and a third memory storing a second copy of the PLC protocol;
wherein, when the system is operating, the at least one sensor sends commands to one or more of the at least one decoder and the at least one sensor sends data to the controller, and the controller stores the data in the at least one memory.

14. The system of claim 13, further comprising a universal device electrically connected to the controller, the universal device including an IEEE 802.11 protocol transceiver and a fourth PLC transceiver, a fourth processor, and a fourth memory storing a third copy of the PLC protocol.

15. The system of claim 14, wherein when the system is powered, the universal device requests identification information from the at least one decoder and the at least one sensor using the first copy of the PLC protocol stored on the second memory and executing on the second processor, the at least one decoder receives the request and sends the identification information using the second copy of the PLC protocol stored in the third memory and executing on the third processor, the at least one sensor receives the request and sends the identification information using the third copy of the PLC protocol stored in the fourth memory and executing on the fourth processor, and the controller uses the identification information to create software for a user to control the at least one decoder and the at least one sensor using the controller.

16. The system of claim 13, wherein. the at least one sensor is a pressure sensor, a moisture sensor, or an electrical conductivity sensor.

17. The system of claim 13, wherein each of the at least one decoder and the at least one sensor send acknowledgements to commands using the power line communication protocol.

18. The system of claim 13, wherein one of the at least one sensor is connected directly to a decoder.

19. The system of claim 13, further comprising two wires which connect the controller to the at least one decoder.

20. The system of claim 19, wherein one or more of the at least one sensor is directly connected to the two wires at a location between the controller and the at least one decoder.
